(19) United States
(12) Patent Application Publication
(10) Pub. No.: US 2021/0269140 A1
(43) Pub. Date: Sep. 2, 2021

(54) CARGO LOADING DEVICE AND UNMANNED AERIAL VEHICLE EMPLOYING THE SAME

(71) Applicant: ELECTRONICS AND TELECOMMUNICATIONS RESEARCH INSTITUTE, Daejeon (KR)

(72) Inventor: Kyeong Soo HAN, Daejeon (KR)

(21) Appl. No.: 17/185,007

(22) Filed: Feb. 25, 2021

(30) Foreign Application Priority Data
Feb. 28, 2020 (KR) 10-2020-0025254
Feb. 23, 2021 (KR) 10-2021-0024093

(51) Int. Cl. B64C 1/22; B64C 39/02; B64D 9/00

(52) U.S. Cl. CPC B64C 1/22; B64C 2201/128; B64D 9/003; B64C 39/024

(57) ABSTRACT

A loading device capable of automatically loading one or more items and unloading the loaded items independently, and an unmanned aerial vehicle including the item loading device. The item loading device includes: a first tray pair comprising two trays each having at least one mounting plate; and an actuator assembly installed over the first tray pair and configured to drive the trays to displace in a direction away from each other or closer to each other. The item is loaded on the mounting plates of the two trays.

### CROSS-REFERENCE TO RELATED APPLICATION

The present application claims the benefit of priority to Korean Patent Application No. 10-2020-0025254 filed on Feb. 28, 2020 and No. 10-2021-0024093 filed on Feb. 23, 2021 with the Korean Intellectual Property Office (KIPO), the entire contents of which are incorporated herein by reference.

### BACKGROUND

### 1. Field of the Invention

The present disclosure relates to a device for loading cargo to be delivered and, more particularly, to a device suitable for being mounted in an unmanned aerial vehicle for automatically loading and unloading cargo. Additionally, the present disclosure relates to an unmanned aerial vehicle employing such a cargo loading device.

### 2. Description of Related Art

Various methods of delivering items using aerial vehicles have been proposed. When an item is delivered using a small unmanned aerial vehicle referred to as a drone, however, loading and unloading of the item is not easy because the loading space is small.

To reduce the loading and unloading labor of operators, U.S. Patent Publication No. 2018/0155142 filed by Amazon Technologies, Inc. and entitled AUTOMATED LOADING SYSTEM discloses a method of loading items using a cable robot and a conveyors. Since this method requires a lot of equipment for loading, however, it may not be easy to apply this loading system to a small unmanned aerial vehicle even though it may suitable for loading a large amount of goods in a vehicle such as a truck.

US Patent Publication No. US 2021/0031919 filed by Wing Aviation LLC and entitled UNMANNED AERIAL VEHICLE AND TECHNIQUES FOR SECURING A PAYLOAD TO THE UAV IN A DESIRED ORIENTATION discloses a method of lowering and unloading a payload by using a cable winch while hovering over a delivery destination. However, this method may cause difficulties in unloading heavy items. In addition, there may still remain an inconvenience that the operator has to squat and load the item under the aerial vehicle since the loading is not performed automatically.

Though demands for a delivery service promptly delivering a small quantities of cargo to recipients are increasing due to temporal or spatial delivery limitations, developments of loading and unloading devices are very slow unlike the advances in aerial vehicle technologies. In this regard, it is known that Korea Post Office, for example, is in need of a device capable of automatically loading two or more boxes and unloading each box independently for a service of delivering boxes using an unmanned aerial vehicle. However, such a device has not been developed yet.

### SUMMARY

Provided is a loading device capable of automatically loading one or more items and unloading the loaded items independently.

Also, provided is an unmanned aerial vehicle including a loading device capable of automatically loading one or more items and unloading the loaded items independently.

According to an aspect of an exemplary embodiment, the present disclosure provides an item loading device installed in an unmanned aerial vehicle for loading at least one item. The item loading device includes: a first tray pair comprising two trays each having at least one mounting plate; and an actuator assembly installed over the first tray pair and configured to drive the trays to displace in a direction away from each other or closer to each other. The item is loaded on the mounting plates of the two trays.

Each of the trays may include: the mounting plate; a vertical plate extending upward from an edge of the mounting plate opposite to another tray included in the first tray pair; and a connection rod having an end coupled to the vertical plate and another end coupled to the actuator.

The item loading device may further include a plurality of spring bars protruding from the vertical plates of the two trays toward the other tray included in the first tray pair.

The item loading device may further include a second tray pair comprising two trays and configured to be driven by the actuator assembly. The item loading device may be capable load a plurality of items.

The actuator assembly may further include: a first and second actuators configured to drive the tray pairs of the first tray pair; and a third and fourth actuators configured to drive the tray pairs of the second tray pair.

The first tray pair and the second tray pair may be driven independently to load respective items separately.

The mounting plates of the first tray pair and the mounting plates of the second tray pair may be disposed to be capable of forming one continuous mounting space thereon. The first tray pair and the second tray pair may be simultaneously driven to jointly load a single item.

The item loading device may further include: a frame housing configured to provide an installation space for the first tray pair and the actuator assembly and protecting the first tray pair and the actuator assembly from an external force and external substances.

The frame housing may include: a first and second sidewalls; and a cross bar connecting rear edges of the first sidewall and the second sidewall and having a predetermined marker formed thereon for alignment with an external loading cart carrying the item on a loading surface to load onto the first tray pair.

The marker may include: a first and second sidewalls; and at least one pair of alignment protrusions configured to receive a predetermined member of the loading cart.

According to another aspect of an exemplary embodiment, the present disclosure provides an unmanned aerial vehicle. The unmanned aerial vehicle includes: a plurality of propellers; a motor configured to rotate the plurality of propellers; a battery configured to supply power to the motor; and a loading device configured to load an item to be delivered. The loading device includes: a first tray pair comprising two trays each having at least one mounting plate; and an actuator assembly installed over the first tray pair and configured to drive the trays to displace in a direction away from each other or closer to each other. The item is loaded on the mounting plates of the two trays.

Each of the trays may include: the mounting plate; a vertical plate extending upward from an edge of the mounting plate opposite to another tray included in the first tray pair; and a connection rod having an end coupled to the vertical plate and another end coupled to the actuator.

The item loading device may further include a plurality of spring bars protruding from the vertical plates of the two trays toward the other tray included in the first tray pair.

The item loading device may further include a second tray pair comprising two trays and configured to be driven by the actuator assembly. The item loading device may be capable load a plurality of items.

The actuator assembly may further include: a first and second actuators configured to drive the tray pairs of the first tray pair; and a third and fourth actuators configured to drive the tray pairs of the second tray pair.

The first tray pair and the second tray pair may be driven independently to load respective items separately.

The mounting plates of the first tray pair and the mounting plates of the second tray pair may be disposed to be capable of forming one continuous mounting space thereon. The first tray pair and the second tray pair may be simultaneously driven to jointly load a single item.

The item loading device may further include: a frame housing configured to provide an installation space for the first tray pair and the actuator assembly and protecting the first tray pair and the actuator assembly from an external force and external substances.

The frame housing may include: a first and second sidewalls; and a cross bar connecting rear edges of the first sidewall and the second sidewall and having a predetermined marker formed thereon for alignment with an external loading cart carrying the item on a loading surface to load onto the first tray pair.

The unmanned aerial vehicle may further include: a processor; and a memory storing at least one instruction executable by the processor. The at least one instruction includes: a loading device open instruction for controlling the actuator assembly to drive the trays to move in a direction away from each other, and an item load instruction for controlling the actuator assembly to drive the trays to move in a direction closer to each other.

According to an embodiment of the present disclosure, the loading device which can automatically load items can make the manual loading works unnecessary and eliminate an uncomfortable situation that an operator enters under the unmanned aerial vehicle to load the items. Thus, the present disclosure may enhance the convenience and efficiency of the loading operation. Since the fixing of the items can be made automatically during the loading process, the present disclosure can improve the safety and reliability of the delivery of cargo using the unmanned aerial vehicle.

The loading device according to an embodiment of the present disclosure not only can load items of various sizes, but also enables to independently load and unload a plurality of items and deliver the plurality of items of different sizes to two or more destinations. Therefore, the utility of the delivery of cargo using the unmanned aerial vehicle may be increased further.

Also, there is an additional advantage that the tray can be driven flexibly and precisely by the ball screw.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram of an example of a mail delivery system to which a delivery drone having a cargo loading device according to an exemplary embodiment of the present disclosure may be applied;

FIG. 2 is a block diagram of the delivery drone shown in FIG. 1;

FIG. 3 is a perspective view of the loading device according to an exemplary embodiment of the present disclosure;

FIG. 4 is a perspective view of a first tray pair and a combination of a first and second actuators in the loading device shown in FIG. 3;

FIG. 5 is an enlarged perspective view of the first actuator according to an exemplary embodiment of the present disclosure;

FIG. 6 is a perspective view of a loading cart according to an exemplary embodiment of the present disclosure;

FIGS. 7A to 7D illustrate a process of loading and unloading an item in the loading device;

FIG. 8A is an illustration of an exemplary state that two items are loaded in the loading device;

FIG. 8B is an illustration of an exemplary state that a single item is loaded in the loading device;

FIG. 9 is an illustration of a state that a separate item is loaded on each of a first tray pair and a second tray pair; and

FIGS. 10A and 10B are illustrations of unloading of the items on the first tray pair and a second tray pair independently.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments and includes all modifications, equivalents, and alternatives falling within the idea and scope of the present disclosure.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” includes any and all combinations of one or more associated items.

When a component is referred to as being “connected” or “coupled” to another component, it means that the component is connected or may be connected logically or physically to the other component. In other words, it is to be understood that the component or may be connected or coupled to the other component indirectly through an object therebetween instead of being directly connected or coupled to the other component.

The terminologies are used herein for the purpose of describing particular embodiments only and are not intended to limit the disclosure. The singular forms include plural referents unless the context clearly dictates otherwise. Also, the expressions “˜ comprises,” “˜ includes,” “˜ constructed,” “˜ configured” are used to refer a presence of a combination of enumerated features, numbers, processing steps, operations, elements, or components, but are not intended to exclude a possibility of a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with meanings in the context of related technologies and should not be interpreted as having ideal or excessively formal meanings unless explicitly defined in the present application.

Hereinafter, embodiments of the present disclosure will be described in more detail with reference to the accompanied drawings. In describing the present disclosure, in order to facilitate an overall understanding thereof, the same components are designated by the same reference numerals in the drawings and are not redundantly described here. Also, detailed descriptions of well-known functions or configuration that may obscure the subject matter of the present disclosure will be omitted for simplicity.

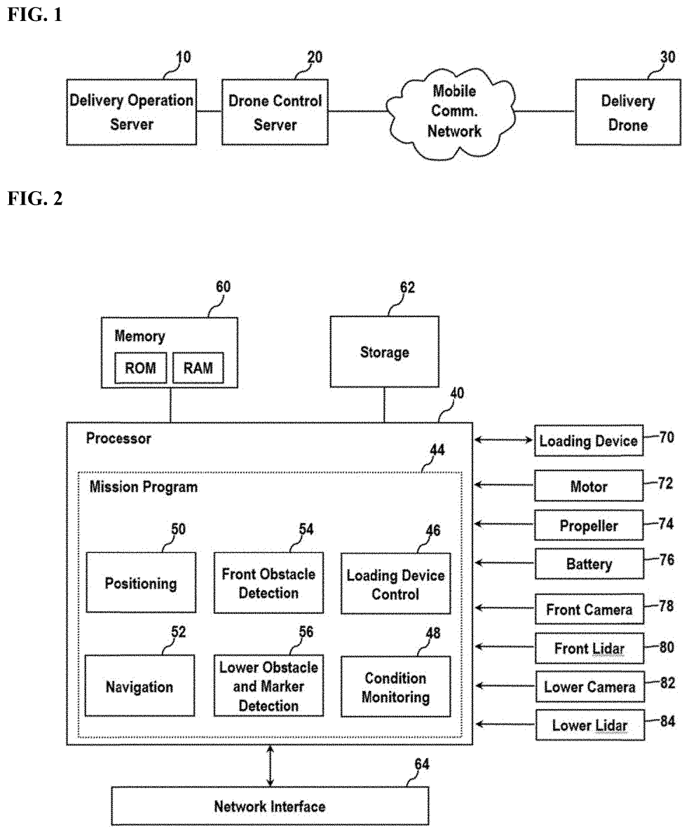

FIG. 1 illustrates an example of a mail delivery system to which a delivery drone having a cargo loading device according to an exemplary embodiment of the present disclosure may be applied.

The mail delivery system shown in the drawing, which is suitable for delivering a mail item to a recipient using a delivery drone 30, may include a delivery operation server 10, a drone control server 10, and the delivery drone 30. The delivery operation server 10 and the drone control server 10 may be installed in a post office, for example, and the delivery drone 30 may be operated based on a post office. The mail item delivered by the mail delivery system using the delivery drone 30 may be a package or a cargo packaged in a box and occupying a volume in a three-dimensional space. However, the present disclosure is not limited thereto, and the mail item may be a document envelope. In the present specification including the claims, all the terms “the mail item”, “package”, “cargo”, and “item” may refer to an object to be delivered have substantially the same meaning in terms of the technical idea of the present disclosure. In the following description, these terms will be used interchangeably depending on the context.

The delivery operation server 10 may receive delivery information for an item that needs to be delivered using the delivery drone 30 and send a delivery request to the drone control server 10. In one embodiment, the delivery operation server 10 may receive item delivery information directly from an operator. Alternatively, however, the delivery operation server 10 may be interfaced to a mail information system of the post office to acquire the item delivery information from the mail information system.

The drone control server 10 may be connected to the delivery operation server 10 through Internet or an intranet. The drone control server 10 may assign a delivery mission to the delivery drone 30 based on the item delivery information from the delivery operation server 10. The drone control server 10 may set a delivery path for each mail item to provide the delivery path information to the delivery drone 30. Alternatively, however, the drone control server 10 may provide the delivery drone 30 with delivery destination information only, and the delivery drone 30 may generate the delivery path based on the positioning information. The drone control server 10 may determine whether the delivery drone 30 can perform a delivery mission, receive flight status data from the delivery drone 30, analyze the flight status of the delivery drone 30, receive real-time video from the delivery drone 30 to display on a monitor, and control the delivery drone 30 based on real-time video.

The drone control server 10 and the delivery drone 30 may be connected with each other through a 4G or 5G-based mobile communications network, for example. The drone control server 10 may deliver the delivery mission to the delivery drone 30 through the mobile communications network. The delivery drone 30 may acquire, during a delivery operation, drone information such as status of the drone, status of a flight, and real-time video, and transmit the acquired information to the drone control server 10 through the mobile communications network.

The delivery drone 30 may perform a mail item delivery mission assigned by the drone control server 10. In other words, the delivery drone 30 loads the mail item into the loading device, flies according to the delivery path provided by the drone control server 10 with reference to positioning data, and unloads the mail item to the destination position of the delivery mission. The delivery drone 30 may use a typical Global Navigation Satellite System (GNSS) signal such as a Global Positioning System (GPS) signal for positioning, but preferably may use a network Real Time Kinematic (RTK) scheme to obtain more accurate location information. The delivery drone 30 may store and execute a mission execution program for performing the flight, the item delivery, and the loading and unloading of the mail item. Also, the delivery drone 30 may include a loading device for accommodating the mail item, and automatically perform an opening and closing of the loading device, and the loading and unloading the mail item through an execution of the mission execution program.

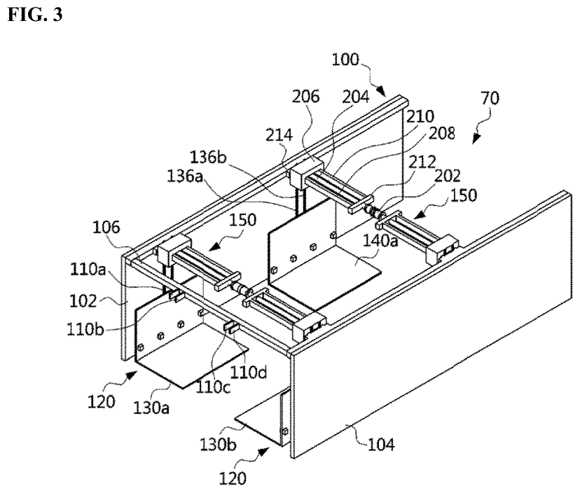

FIG. 2 is a block diagram of the delivery drone 30 shown in FIG. 1.

The delivery drone 30 according to an exemplary embodiment may include at least one processor 40, a memory 60, a storage 62, and a network interface 64. The delivery drone 30 may further include the loading device 70, at least one motor 72, a propeller 74, a battery 76, a front camera 78, a front lidar 80, a lower camera 82, and a lower lidar 84.

The processor 40 may execute program instructions stored in the memory 60 and/or the storage 62. The processor 40 may be at least one central processing unit (CPU), a graphics processing unit (GPU), or another kind of dedicated processor suitable for performing processes according to the present disclosure.

The memory 60 may include, for example, a volatile memory such as a read only memory (ROM) and a nonvolatile memory such as a random access memory (RAM). The memory 60 may load the program instructions stored in the storage 62 to provide to the processor 40.

The storage 62 may include an intangible recording medium suitable for storing the program instructions, data files, data structures, and a combination thereof. Any device capable of storing data that may be readable by a computer system may be used for the storage. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

The network interface 64 allows the processor 40 to communicate with an external device such as the drone control server 20 over the Internet. Also, the network interface 64 may include a modem and a protocol stack for communicating with the drone control server 20 over the mobile communications network, for example.

The loading device 70 is a device that loads the mail item or the cargo to be delivered to the recipient. The loading device 70 according to an exemplary embodiment may be functionally divided into two loading spaces disposed in a front and rear direction so as to be capable of loading up to two mail items. Since there is no partition physically separating the two loading spaces, the two loading spaces may be used as a single large loading space for loading one large mail item. Opening and closing of the loading device 70, and loading and unloading of the mail item may be performed automatically through the execution of the mission execution program. The detailed configuration and operation of the loading device 70 will be described below.

As mentioned above, the delivery drone 30 is equipped with and executes the mission execution program 44 for the flight, the delivery, and the loading and unloading of the mail item. The mission execution program may be stored in the storage 62, loaded into the memory 60, and executed by the processor 40. In one embodiment, the mission execution program 44 may include a loading device control process 46, a condition monitoring process 48, a positioning process 50, a navigation process 52, a forward obstacle detection process 54, and a lower obstacle and marker detection process 56.

The loading device control process 46 sends a loading device open command and an item load command to the loading device 70 when an item needs to be loaded into the loading device 70, so that the loading device 70 opens an inlet and loads the item. The loading device control process 42 sends an item unload command and a loading device close command to the loading device 70 when it is necessary to unload an item needs to be unloaded from the loading device 70, so that the loading device 70 unloads the item and closes an outlet. The outlet may be the same as the inlet. The loading device control process 42 can control the opening and closing of each of the two loading spaces disposed in the front and rear direction in the loading device 70, so that the items can be loaded in each of the loading spaces and can be unloaded independently.

The condition monitoring process 48 monitors the operation status of essential components of the delivery drone 30 such as the motor 72 and propeller 74, a voltage level of the battery 76, and a temperature inside the delivery drone 30. When an abnormal condition which may be critical to the flight such as a non-operation of the motor 72 or the propeller 74 or a low voltage condition of the battery 76 is detected, the condition monitoring process 44 informs the abnormal condition to the control server 20.

The positioning process 50 acquires current coordinates, i.e. a latitude, a longitude, and an altitude, of the delivery drone 30 based on the GNSS signal. The navigation process 52 controls a take-off and landing and an operation of the delivery drone 30 so that the delivery drone 30 operates according to the preset navigation path based on position data acquired by the positioning process 50.

The forward obstacle detection process 54 may collect data on moving obstacles and fixed obstacles that the delivery drone 30 may encounter during the flight. The forward obstacle detection process 54 can recognize an object in a front image acquired by the front camera 78 and estimate a type of a recognized object, and detect a relative position in the image. Also, the forward obstacle detection process 54 can detect an obstacle in front of the delivery drone 30 using the front lidar 80 and calculate a distance to a detected obstacle and an angle range in a left and right directions of the obstacle. The forward obstacle detection process 54 may estimate positions and speeds of the moving obstacles and the fixed obstacles in front of the delivery drone 30 by combining the front image and the front lidar output. The detection of the obstacle by the forward obstacle detection process 54 may be performed based on an obstacle detection model built through a learning in a system environment external to the delivery drone 30 before being mounted on the delivery drone 30.

The lower obstacle and marker detection process 56 may collect data on an obstacle that the delivery drone 30 may encounter during a landing operation and a marker indicating a geographic location. Here, the obstacle may include a human beings and an animal such as a dog and a cat. The lower obstacle and marker detection process 56 may detect the obstacle and the marker in a lower image acquired by the lower camera 82. The lower obstacle and marker detection process 56 may change a model for detecting the lower obstacle and the landing marker to another model according to an altitude of the delivery drone 30. For example, an object detected at an altitude above a certain threshold may be recognized as a lower obstacle while another object detected at an altitude below the threshold may be recognized as an obstacle or a landing marker depending on circumstances. Also, the lower obstacle and marker detection process 56 can detect a lower obstacle using the lower lidar 84 and calculate a distance to the lower obstacle and a range of the obstacle. The lower obstacle and marker detection process 56 may estimate the position and speed of the obstacle by combining the lower image and the lower lidar output. The detection of the obstacle by the lower obstacle detection process 56 may be performed based on an obstacle and marker detection model built through a learning in a system environment external to the delivery drone 30 before being mounted on the delivery drone 30.

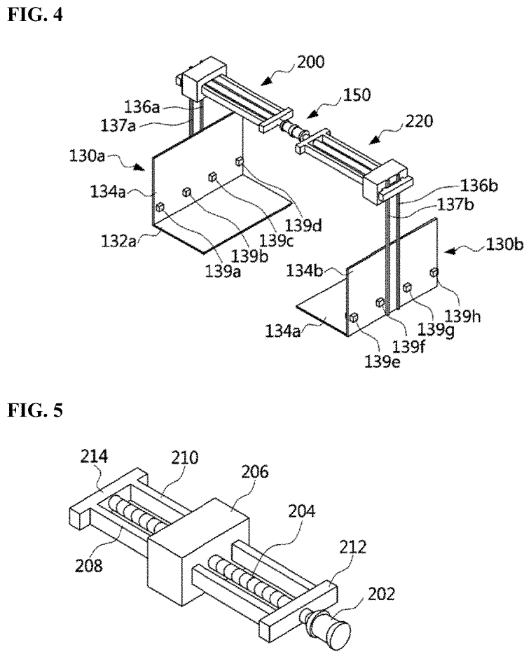

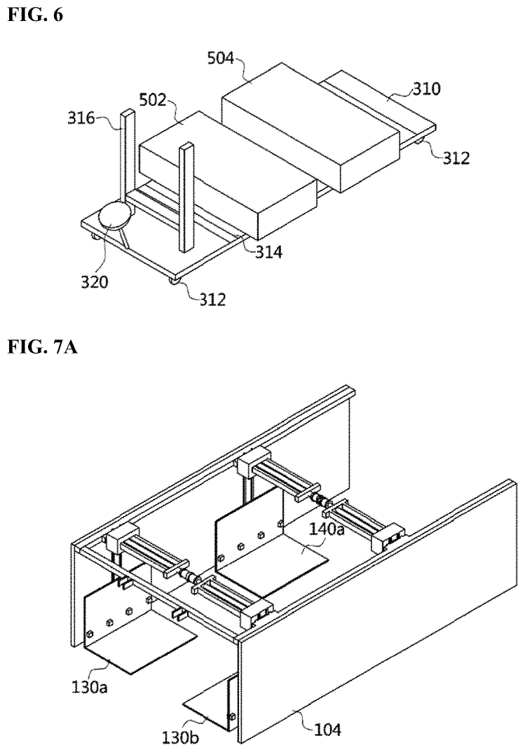

FIG. 3 is a perspective view of the loading device 70 according to an exemplary embodiment of the present disclosure, and FIG. 4 is a perspective view of a first tray pair and a combination of a first and second actuators in the loading device 70 shown in FIG. 3.

The loading device 70 according to the present embodiment may include a housing frame 100 disposed in a lower portion of the delivery drone 30, a loading tray 120 provided in the housing frame 100, and an actuator assembly 150 driving the loading tray 120. The housing frame 100 defines a maximum range of the loading device 70 and protects the loading tray 120 and the actuator assembly 150 from external materials or external forces. The loading tray 120 can load items and keep a loading state. The actuator assembly 150 can drive the loading tray 120 to load the mail item and unload a loaded item.

The housing frame 100 may include a first sidewall 102 formed in the left of the drawing, a second sidewall 104 facing the first sidewall 102, and a cross bar 106 connecting the rear upper end of the first and second sidewalls 102 and 104. Two pairs of alignment protrusions 110A-110D may be formed to protrude from the rear surface of the cross bar 106. Alternatively, a planar marker may be formed on the rear surface of the cross bar 106 instead of forming the three-dimensional alignment protrusions 110A-110D.

The loading tray 120, which is a device that actually loads and unloads the item, may include a first tray pair comprised of a first tray 130A and a second tray 130B and a second tray pair comprised of a third tray 140A and a fourth tray 140B. The first tray pair and the second tray pair may be independently driven by the actuator assembly 150. Accordingly, each of the first tray pair and the second tray pair may load separate items, or the first tray pair and the second tray pair may load one large item together.

The first tray 130A may include a mounting plate 132A extending at least partially toward the second tray 130B from near a lower end of the first side wall 102 of the housing frame 100, a vertical plate 134A extending upward from an outer side of the mounting plate 132A, and connection rods 136A and 137A each having one end coupled to the vertical plate 134A and extending toward the actuator 150. The second tray 130B may include a mounting plate 132B extending at least partially toward the first tray 130A from near a lower end of the second sidewall 104 of the housing frame 100, a vertical plate 134B extending upward from an outer side of the mounting plate 132B, and driving bars 136B and 137B each having one end coupled to the vertical plate 134B and extending toward the actuator 150.

The third tray 140A may include a mounting plate 142A extending at least partially toward the fourth tray 140B from near a lower end of the first side wall 102 of the housing frame 100, a vertical plate 144A extending upward from an outer side of the mounting plate 142A, and driving bars 146A and 147A each having one end coupled to the vertical plate 134A and extending toward the actuator 150. Although not shown in detail in FIG. 3 or 4, the fourth tray 140B may be configured similarly to the first to third trays 130A, 130B, and 140A.

Meanwhile, a plurality of spring bars 139A-139H are formed in the vertical plate 134A of the first tray 130A and the vertical plate 134B of the second tray 130B to protrude toward the inside of the loading device 70. Each of the spring bars 139A-139H can be pressed by an item loaded on the first tray 130A and the second tray 130B, and can maintain a compressed state while being pressed by the item. In this compressed state, each of the spring bars 139A-139H may exert an elastic force on the item and prevent the item from moving further toward the spring bar 139A-139H. Meanwhile, some of the spring bars 139A-139H which are not compressed by the item maintain a state of being protruded toward the inside of the loading device 70, and can act as locking jaws preventing the item from moving in a front or rear direction within the loading device 70. Thus, the spring bars 139A-139H may fix the item and prevent the item from unintentionally moving in the right or left direction or the forward or backward directions.

Spacing between adjacent spring bars 139A-139H in the same tray may be uniform, but may be different from each other. Also, the spacing between adjacent the spring bars 139A-139H may be fixed, but may be variable. For example, The tray and the spring bars may configured such that a plurality of installation holes for inserting spring bars are formed in the vertical plate 134A of the first tray 130A at regular spaces and the spring bars may be selectively installed in at least some of the plurality of installation holes according to the size of the item and the delivery mission.

The actuator assembly 150 may be controlled by the mission execution program 44 to drive the first and second tray pairs in a transverse direction to allowing the first and second tray pairs to load or unload the item. The actuator assembly 150 may include a first through fourth actuators 200, 220, 240, and 260 disposed over the first through fourth trays 130A, 130B, 140A, and 140B to drive the first through fourth trays 130A, 130B, 140A, and 140B, respectively.

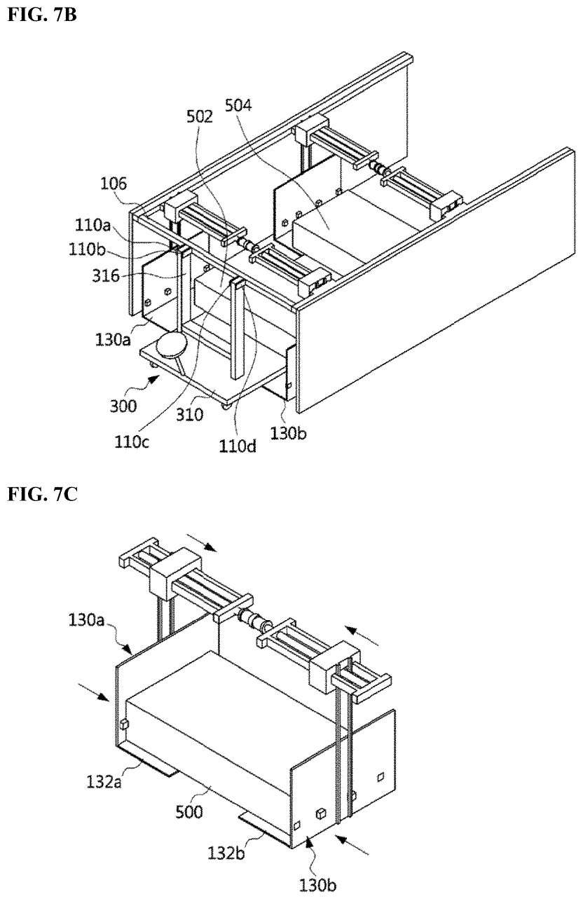

FIG. 5 is an enlarged perspective view of the first actuator 200 according to an exemplary embodiment of the present disclosure. The first actuator 200 according to the present embodiment is a linear actuator using a ball screw and includes a motor 202, a ball screw 204, a carriage 206, linear guides 208 and 210, a first support member 212, and a second support member 214.

The ball screw 204 is formed with a thread capable of accommodating ball bearings on its circumferential surface, and one end of the ball screw 204 is axially coupled to a rotating shaft of the motor 202. The carriage 206 is installed on the ball screw 204 and may be transported left and right according to a rotation of the ball screw 204. The linear guides 208 and 210 guide the transport of the carriage 206 on both sides of the ball screw 204. The first support member 212 is installed at the end of the ball screw 204 on the motor 202 side to support the motor 202 and one ends of the linear guides 208 and 210. The second support member 214 may be attached on a top of the first sidewall 102 of the housing frame 100 to support the ball screw 204 and the other ends of the linear guides 208 and 210.

The carriage 206 has a through hole extending in the left and right directions to receive the ball screw 204. A thread is formed on an inner surface of the through hole to enable to operate as a ball nut. The thread engages with the ball screw 204 via the ball bearings (not shown). Also, two guide holes are formed in the carriage 206 in parallel with the through hole to allow the linear guides 208 and 210 to pass through the guide holes. Accordingly, the carriage 206 is transported linearly to the right or left according to the rotation of the motor 202, and the transport direction of the carriage 206 changes according to the rotation direction of the motor 202.

Upper ends of the connection rods 136a and 137a of the first tray 130A may be coupled on one side of the carriage 206. For example, the connection rod 136a may be coupled between an entrance of the through hole and an entrance of one guide hole of the carriage 206, and the other connection rod 137a may be coupled between the entrance of the through hole and an entrance of another guide hole. The upper ends of the connection rods 136a and 137a may be engaged to the carriage 206 by use of screws, for example. Thus, when the carriage 206 is transported left and right due to the rotation of the motor 202, the first tray 130A moves left and right correspondingly.

The second actuator 220 is be configured and driven in the same fashion as the first actuator 200 except that the second actuator 220 is configured and driven to move symmetrically to the first actuator 200. In other words, when the carriage 206 of the first actuator 200 is transported toward the motor 202, the carriage of the second actuator 220 is transported toward the motor also. When the carriage 206 of the first actuator 200 is transported toward the first sidewall 102, the carriage of the second actuator 220 is transported toward the second sidewall 104.

In the process of loading the item, the carriage 206 of the first actuator 200 can be transported in a first direction, which is the right direction in the drawing, along the linear guides 208 and 210, and the first tray 130A coupled to the carriage 206 can be moved in the first direction. At this time, the carriage of the second actuator 220 installed symmetrically with the first actuator 200 can be transported in a second direction, which is the left direction in the drawing, along linear guides, and the second tray 130B coupled to the carriage can be moved in the second direction. Thus, due to the operation of the first and second actuators 200 and 220, the first and second trays 130A and 130B move in a direction approaching to each other.

In the process of unloading the item, the carriage 206 of the first actuator 200 can move in the second direction, which is the left direction in the drawing, along the linear guides 208 and 210, and the first tray 130A coupled to the carriage 206 can be moved in the second direction. At this time, the carriage of the second actuator 220 installed symmetrically with the first actuator 200 can be transported in the first direction, which is the right direction in the drawing, along the linear guide, and the second tray 130B coupled to the carriage can be moved in the first direction. Thus, due to the operation of the first and second actuators 200 and 220, the first and second trays 130A and 130B move in a direction away from each other.

Meanwhile, the third and fourth actuators 240 and 260 may be configured identically to the first and second actuators 200 and 220, respectively. Detailed description of the second through fourth actuators 220, 240, and 260 is omitted for simplicity since they can be implemented easily based on the description and drawings of the first actuator 200.

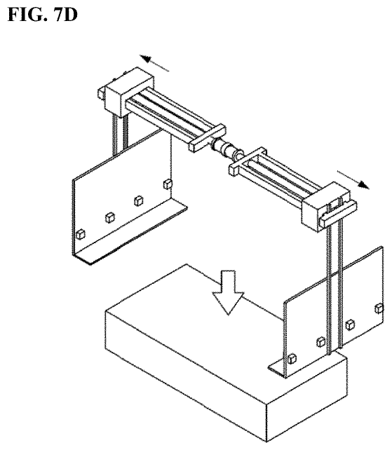

According to an exemplary embodiment of the present disclosure, the loading of the item into the loading device 70 may be performed using a loading cart. FIG. 6 is a perspective view of the loading cart according to an exemplary embodiment of the present disclosure. The loading cart 300, which may be used to move one or two items to the delivery drone 30 and loading them to the loading device 70, includes a mounting plate 310 having a plurality of wheels 312 attached thereto, and a handle 320 installed to one side of the mounting plate 310.

One or more marker lines 314 may be scribed on the mounting plate 310. In one embodiment, the marker line 314 may indicate an item placement position on the mounting plate 310 to facilitate the loading of the item from the loading cart 300 to the loading device 70 of the delivery drone 30. A plurality of marker lines 314 may be scribed on the mounting plate 310 so that each of the marker lines 314 corresponds to a different size of the item. Alternatively, the marker lines 314 may be used for the delivery drone 30 to visually recognize the position of the item on the mounting plate 310.

One or more alignment bars 316 may be provided on the mounting plate 310. In one embodiment, the alignment bar 316 has a shape of a bar extending upward from the mounting plate 310. The length of the alignment bars 316 may be slightly larger than a height of the cross bar 106 of the housing frame 100. Horizontal positions of the alignment bars 316 on the mounting plate 310 may correspond to the alignment protrusions 110A-110D or the planar markers provided on the cross bar 106 of the housing frame 100. When loading the item into the loading device 70, the mounting plate 310 of the loading cart 300 may be pushed under the delivery drone 30 while the alignment bars 316 are aligned with the alignment protrusions 110A-110D or the planar markers. In case that the item is loaded while the alignment bars 316 are aligned with the alignment protrusions 110a to 110d or the planar markers as such, a center of gravity of the loading device 70 may not change excessively after the loading of the item and the internal space of the loading device 70 can be fully utilized.

Hereinafter, the process of loading and unloading the item in the loading device 70 of the delivery drone 30 will be described in more detail.

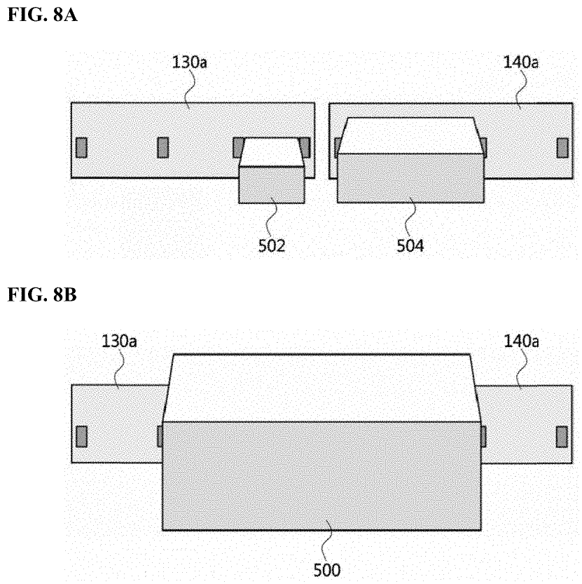

When the processor 40 executing the mission execution program 44 gives an open command for the first tray pair of the loading device 70, the motors of the first and second actuators 200 and 220 rotate. Accordingly, the carriage 206 of the first actuator 200 is transported in the second direction, which is the left direction in the drawing, along the linear guides 208 and 210, and the carriage of the second actuator 220 is transported in the first direction, which is the right direction in the drawing, along the linear guides. Thus, the first and second trays 130A and 130B move in the direction further away from each other, and the loading device 70 is completely opened as shown in FIG. 7A.

In a state that the first pair of trays are fully open, the mounting plate 310 of the loading cart 300 can be pushed between the first and second trays 130A and 130B with the items 502 and 504 placed thereon as shown in FIG. 7B. Afterwards, when the item load command for the first tray pair of the loading device 70 is applied from the processor 40, the carriage 206 of the first actuator 200 is transported in the first direction, which is the right direction in the drawing, along the linear guides 208 and 210 and the carriage of the second actuator 220 is transported in the second direction, which is the left direction in the drawing, along the linear guides due to the rotation of the motors. Thus, the first and second trays 130A and 130B move in the direction getting closer to each other, and the mounting plates 132a and 132b of the first and second trays 130A and 130B are inserted between the item 502 and the mounting plate 310 of the loading cart 300 so that the item 502 is moved onto the mounting plates 132A and 132B.

The movement of the first and second trays 130A and 130B may continue until the item 502 is in close contact with at least some of the plurality of spring bars 139A-139H or the vertical surfaces 134A and 134B. The loaded item 502 is restricted from moving in the left and right directions by the vertical surfaces 134A and 134B of the first and second trays 130A and 130B or some of the spring bars 139A-139H. Meanwhile, the movement of the item 502 in the forward and backward directions may be limited by some uncompressed spring bars 139A-139H. The item can be automatically fixed during the loading process in this way.

When the item unload command is applied from the processor 40 after the delivery drone 30 arrives at the destination, the carriage 206 of the first actuator 200 is transported in the second direction, which is the left direction in the drawing, along the linear guides 208 and 210 and the carriage of the second actuator 220 is transported in the first direction, which is the right direction in the drawing, along the linear guides due to the rotation of the motors. Thus, the first and second trays 130A and 130B move in the direction further away from each other and the loading device 70 is opened, so that the item 502 can be unloaded downward by gravity as shown in FIG. 7D. The unloading of the item may include the unloading of the item after landing of the delivery drone 30 and taking off again, or discharging the item while hovering at a low altitude.

Afterwards, in response to the loading device close command from the processor 40, the first and second trays 130A and 130B may be moved and the loading device 70 can be closed again. However, the present disclosure is not limited thereto, and the loading device 70 is not necessarily closed after unloading the item. On the other hand, a door for protecting the item and the loading device 70 may be additionally provided under the housing frame 100 of the loading device 30 in an alternative embodiment.

As described above, the first and second trays 130A and 130B may be separated apart by a predetermined distance when the loading starts, and move in the directions getting closer to each other in response to a command from the processor 40 executing the mission execution program when the item loaded on the loading cart 300 comes in therebetween. The spring bars 139A-139H installed on the vertical plates of the trays 130A and 130B can support the item in a state of being compressed by the item, but latch the item by acting as locking jaws in the uncompressed state to limit the forward or backward movement of the item.

Though the loading and unloading of the item by the first tray pair having the first and second trays 130A and 130B has been described above, the second tray pair having the third and fourth trays 140A and 140B may perform the loading and unloading operation in the same manner. Also, as mentioned above, the first tray pair and the second tray pair may be driven independently by the actuator 150, and each of the first tray pair and the second tray pair may load the item independently. However, the first tray pair and the second tray pair may load one large item together as well.

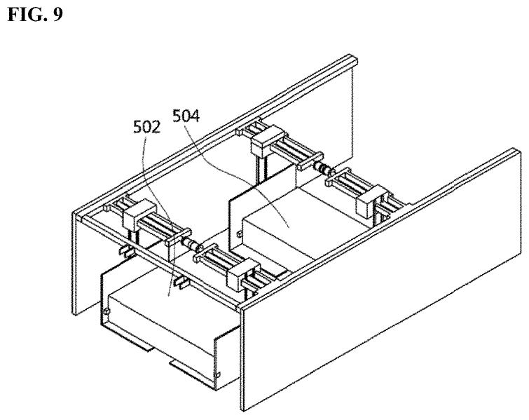

As such, the first tray pair and the second tray pair may form two loading spaces disposed in the front and rear direction in the loading box 70, so that the loading box 70 can load up to two items. FIG. 8A is an illustration of an exemplary state that two items 502 and 504 are loaded in the loading device 70. On the other hand, since there is no physical partition separating the two loading spaces, the two loading spaces can be used as one large loading space to load one large item. FIG. 8B is an illustration of an exemplary state that a single item 500 is loaded in the loading device.

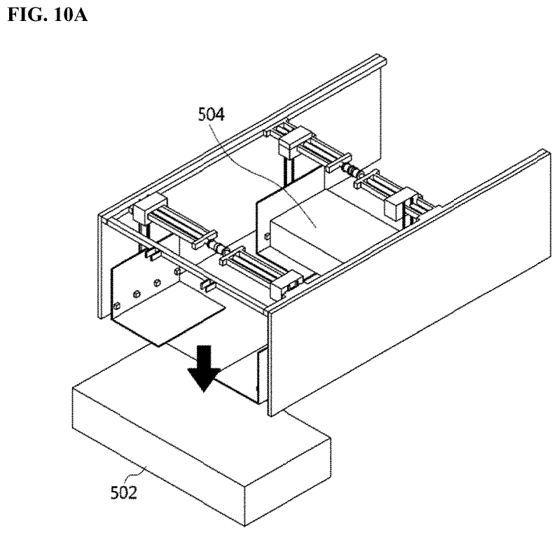

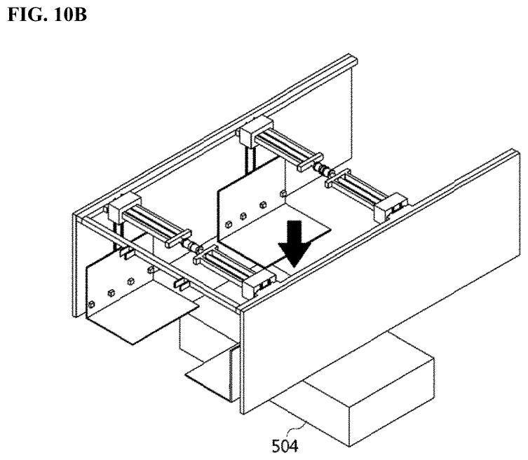

FIG. 9 is an illustration of a state that items 502 and 504 are loaded on the first tray pair and the second tray pair, respectively. Each of the items loaded on the first tray pair and the second tray pair can be unloaded at a different destination. That is, the first item 502 loaded on the first tray pair can be unloaded at a first delivery point as shown in FIG. 10A, and the second item 504 loaded on the second tray pair can be unloaded at a second delivery point as shown in FIG. 10B.

Some aspects of the present disclosure have been described above in the context of a device but may be described using a method corresponding thereto. Here, blocks or the device corresponds to operations of the method or characteristics of the operations of the method. Similarly, aspects of the present disclosure described above in the context of a method may be described using blocks or items corresponding thereto or characteristics of a device corresponding thereto. Some or all of the operations of the method may be performed, for example, by (or using) a hardware device such as a microprocessor, a programmable computer or an electronic circuit. In some exemplary embodiments, at least one of most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

Although exemplary embodiments of the present disclosure has been described above, the present disclosure can be modified in various ways without departing from its technical spirit or changing essential features thereof, and can be implemented in other specific forms.

For example, embodiments in which the trays 130A, 130B, 140A, and 140B are driven by a linear actuator have been described above, another actuator device such as those employing an air pressure-driven cylinder, a belt, a rack and pinion gears, and so on to convert the rotational motion of the motor into a linear motion may be used. Also, although separate actuators each having a separate motor are used to drive the first and second trays 130A and 130B in the above description, only a single motor may be used for the first and second trays. In such a case, the rotational force of the motor can be transmitted to the two ball screws by use of a belt and belt pulleys, or a chain and chain pulleys, for example.

It has been described above that each actuator such as the first actuator 200 includes two linear guides 208 and 210, but either of the two linear guides 208 and 210 may be omitted.

The loading cart 300 used to load the item into the loading device 70 may be a manual cart, but may also be a self-powered transfer device that can operate by its own power such as a forklift or a robot cart.

Although above description was focused on the delivery of the mail item by the post office, the unmanned aerial vehicle of the present disclosure may be used by other entities to transport other types of cargo. The item to be delivered is not limited to boxed cargo occupying a three-dimensional volume, but may be a letter or document contained in an envelope.

The loading device open command and the item load command have been described separately, but these two commands may be combined into a single command. Also, though the item unload command and the loading device close command have been described separately, these two commands may be combined into another single command.

Therefore, the description presented above is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An item loading device installed in an unmanned aerial vehicle for loading at least one item, comprising:
a first tray pair comprising two trays each having at least one mounting plate; and
an actuator assembly installed over the first tray pair and configured to drive the trays to displace in a direction away from each other or closer to each other,
wherein the item is loaded on the mounting plates of the two trays.

2. The item loading device of claim 1, wherein each of the trays comprises:
the mounting plate;
a vertical plate extending upward from an edge of the mounting plate opposite to another tray included in the first tray pair; and
a connection rod having an end coupled to the vertical plate and another end coupled to the actuator.

3. The item loading device of claim 2, further comprising:
a plurality of spring bars protruding from the vertical plates of the two trays toward the other tray included in the first tray pair.

4. The item loading device of claim 1, further comprising:
a second tray pair comprising two trays and configured to be driven by the actuator assembly,
wherein the item loading device is capable load a plurality of items.

5. The item loading device of claim 4, wherein the actuator assembly further comprises:
a first and second actuators configured to drive the tray pairs of the first tray pair; and
a third and fourth actuators configured to drive the tray pairs of the second tray pair.

6. The item loading device of claim 4, wherein the first tray pair and the second tray pair are driven independently to load respective items separately.

7. The item loading device of claim 4, wherein the mounting plates of the first tray pair and the mounting plates of the second tray pair are disposed to be capable of forming one continuous mounting space thereon,
wherein the first tray pair and the second tray pair are simultaneously driven to jointly load a single item.

8. The item loading device of claim 1, further comprising:
a frame housing configured to provide an installation space for the first tray pair and the actuator assembly and protecting the first tray pair and the actuator assembly from an external force and external substances.

9. The item loading device of claim 1, wherein the frame housing comprises:
a first and second sidewalls; and
a cross bar connecting rear edges of the first sidewall and the second sidewall and having a predetermined marker formed thereon for alignment with an external loading cart carrying the item on a loading surface to load onto the first tray pair.

10. The item loading device of claim 9, wherein the marker comprises:
a first and second sidewalls; and
at least one pair of alignment protrusions configured to receive a predetermined member of the loading cart.

11. An unmanned aerial vehicle comprising:
a plurality of propellers;
a motor configured to rotate the plurality of propellers;
a battery configured to supply power to the motor; and
a loading device configured to load an item to be delivered;
wherein the loading device comprises:
a first tray pair comprising two trays each having at least one mounting plate; and
an actuator assembly installed over the first tray pair and configured to drive the trays to displace in a direction away from each other or closer to each other,
wherein the item is loaded on the mounting plates of the two trays.

12. The item loading device of claim 11, wherein each of the trays comprises:
the mounting plate;
a vertical plate extending upward from an edge of the mounting plate opposite to another tray included in the first tray pair; and
a connection rod having an end coupled to the vertical plate and another end coupled to the actuator.

13. The item loading device of claim 12, further comprising:
a plurality of spring bars protruding from the vertical plates of the two trays toward the other tray included in the first tray pair.

14. The item loading device of claim 11, further comprising:
a second tray pair comprising two trays and configured to be driven by the actuator assembly,
wherein the item loading device is capable load a plurality of items.

15. The item loading device of claim 14, wherein the actuator assembly further comprises:
a first and second actuators configured to drive the tray pairs of the first tray pair; and
a third and fourth actuators configured to drive the tray pairs of the second tray pair.

16. The unmanned aerial vehicle of claim 14, wherein the first tray pair and the second tray pair are driven independently to load respective items separately.

17. The unmanned aerial vehicle of claim 14, wherein the mounting plates of the first tray pair and the mounting plates of the second tray pair are disposed to be capable of forming one continuous mounting space thereon,
wherein the first tray pair and the second tray pair are simultaneously driven to jointly load a single item.

18. The unmanned aerial vehicle of claim 11, further comprising:
a frame housing configured to provide an installation space for the first tray pair and the actuator assembly and protecting the first tray pair and the actuator assembly from an external force and external substances.

19. The unmanned aerial vehicle of claim 18, wherein the frame housing comprises:
a first and second sidewalls; and
a cross bar connecting rear edges of the first sidewall and the second sidewall and having a predetermined marker formed thereon for alignment with an external loading cart carrying the item on a loading surface to load onto the first tray pair.

20. The unmanned aerial vehicle of claim 11, further comprising:
a processor; and
a memory storing at least one instruction executable by the processor,
wherein the at least one instruction comprises:
a loading device open instruction for controlling the actuator assembly to drive the trays to move in a direction away from each other; and
an item load instruction for controlling the actuator assembly to drive the trays to move in a direction closer to each other.
